(19) United States
(12) Patent Application Publication
(10) Pub. No.: US 2013/0232412 A1
(43) Pub. Date: Sep. 5, 2013

(54) METHOD AND APPARATUS FOR PROVIDING MEDIA EVENT SUGGESTIONS

(71) Applicants: Antti Johannes Eronen, Tampere (FI); Toni Heittola, Tampere (FI); Annamaria Mesaros, Tampere (FI); Tuomas Virtanen, Tampere (FI)

(72) Inventors: Antti Johannes Eronen, Tampere (FI); Toni Heittola, Tampere (FI); Annamaria Mesaros, Tampere (FI); Tuomas Virtanen, Tampere (FI)

(73) Assignee: NOKIA CORPORATION, Espoo (FI)

(21) Appl. No.: 13/410,685

(22) Filed: Mar. 2, 2012

(51) Int. Cl. G06F 3/01

(52) U.S. Cl. 715/716

(57) ABSTRACT

Various methods are described for providing media event suggestions based at least in part on a co-occurrence model. One example method may comprise receiving a selection of at least one media event to include in a media composition. Additionally, the method may comprise determining at least one suggested media event based at least in part on the at least one media events. The method may further comprise causing display of the at least one suggested media event. Similar and related methods, apparatuses, and computer program products are also provided.

### TECHNICAL FIELD

Embodiments of the present invention relate generally to media technology, and, more particularly, relate to a method and apparatus for providing media event suggestions based at least in part on a co-occurrence model.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Mobile devices are being used for an increasing number of tasks previously reserved for conventional desktop and laptop computers. One such example involves the creation and editing of media presentations. The use of mobile devices for media editing, however, presents additional difficulties and constraints. For example, mobile devices are typically limited to smaller display sizes and decreased storage and processing capabilities. As a result, it may be difficult for a user to have access to large amounts of media components to use in when creating or mixing a media presentation. Furthermore, users may experience challenges in locating and obtaining media components that would be suitable for inclusion in the media presentation.

Accordingly, it may be desirable to provide systems, methods, apparatuses, and computer program products for providing suggestions of various media components, such as media events or media segments, that a user may be interested in including in a media composition based at least in part on a co-occurrence model.

### SUMMARY

Methods, apparatuses, and computer program products are herein provided for providing media event suggestions based at least in part on a co-occurrence model. In an example embodiment, a method is provided, comprising receiving a selection of at least one media event to include in a media composition. The method may further comprise determining at least one suggested media event based at least in part on the at least one media events. The example method may also comprise causing display of the at least one suggested media event.

In another example embodiment, an apparatus comprising at least one processor and at least one memory storing computer program code is provided. The at least one memory and stored computer program code may be configured, with the at least one processor, to cause the apparatus of this example embodiment to at least receive a selection of at least one media event to include in a media composition. The at least one memory and stored computer program code, with the at least one processor, may be further configured to determine at least one suggested media event based at least in part on the at least one media events. Additionally, the at least one memory and stored computer program code, with the at least one processor, may be configured to cause display of the at least one suggested media event.

In yet another example embodiment, a computer program product is provided. The computer program product of this example embodiment includes at least one computer-readable storage medium having computer-readable program instructions stored therein. The program instructions of this example embodiment may comprise code for receiving a selection of at least one media event to include in a media composition. The program instructions of this example embodiment may further comprise code for determining at least one suggested media event based at least in part on the at least one media events. Additionally, the program instructions of this example embodiment may comprise code for causing display of the at least one suggested media event.

In another example embodiment, an apparatus is provided, which comprises means for receiving a selection of at least one media event to include in a media composition. The apparatus may further comprise means for determining at least one suggested media event based at least in part on the at least one media events. The example apparatus may also comprise means for causing display of the at least one suggested media event.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described some example embodiments of the invention in general terms, reference will now be made to the accompanying drawings, which are not necessarily drawn to scale, and wherein:

FIG. 1 illustrates a system for providing media event suggestions based at least in part on a co-occurrence model according to some example embodiments of the present invention;

FIG. 2 illustrates a schematic block diagram of a mobile terminal according to some example embodiments of the present invention;

FIG. 3 illustrates a block diagram of an apparatus according to some example embodiments of the present invention; and

FIG. 4 illustrates a flowchart according to an example method for providing media event suggestions based at least in part on a co-occurrence model to some example embodiments of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

The terms “data,” “content,” “information,” and similar terms may be used interchangeably, according to some example embodiments of the present invention, to refer to data capable of being transmitted, received, operated on, displayed, and/or stored. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a floppy disk, a flexible disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

As used herein, the term ‘circuitry’ refers to all of the following: (a) hardware-only circuit implementations (such as implementations in only analog and/or digital circuitry); (b) to combinations of circuits and computer program product(s) comprising software (and/or firmware instructions stored on one or more computer readable memories), such as (as applicable): (i) to a combination of processor(s) or (ii) to portions of processor(s)/software (including digital signal processor(s)), software, and memory(ies) that work together to cause an apparatus, such as a mobile phone or server, to perform various functions described herein); and (c) to circuits, such as, for example, a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, other network device, and/or other computing device.

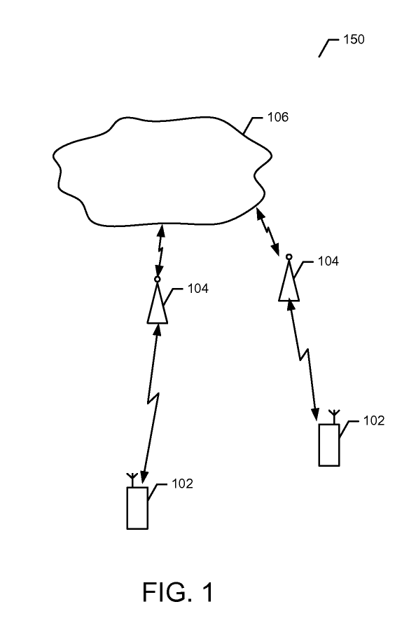

Referring now to FIG. 1, FIG. 1 illustrates a block diagram of a system 150 for providing media event suggestions based at least in part on a co-occurrence model. It will be appreciated that the system 150 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing media event suggestions based at least in part on a co-occurrence model, numerous other configurations may also be used to implement embodiments of the present invention.

The system 150 may include one or more terminal apparatuses 102 and one or more serving network apparatuses 104. The system 150 may further comprise a network 106. The network 106 may comprise one or more wireline networks, one or more wireless networks, or some combination thereof. The network 106 may, for example, comprise a serving network (e.g., a serving cellular network) for one or more terminal apparatuses 102. The network 106 may comprise, in certain embodiments, one or more of the terminal apparatuses 102 and serving network apparatuses 104 themselves. According to example embodiments, the network 106 may comprise the Internet. The network 106 may comprise, in some embodiments, a Content Delivery Network (CDN), which may also be referred to as a Content Distribution Network. In various embodiments, the network 106 may comprise a wired access link connecting one or more terminal apparatuses 102 to the rest of the network 106 using, for example, Digital Subscriber Line (DSL) technology. In some embodiments, the network 106 may comprise a public land mobile network (for example, a cellular network), such as may be implemented by a network operator (for example, a cellular access provider). The network 106 may operate in accordance with universal terrestrial radio access network (UTRAN) standards, evolved UTRAN (E-UTRAN) standards, current and future implementations of Third Generation Partnership Project (3GPP) LTE (also referred to as LTE-A) standards, current and future implementations of International Telecommunications Union (ITU) International Mobile Telecommunications-Advanced (IMT-A) systems standards, and/or the like. It will be appreciated, however, that where references herein are made to a network standard and/or terminology particular to a network standard, the references are provided merely by way of example and not by way of limitation.

According to various embodiments, one or more terminal apparatuses 102 may be configured to connect directly with one or more serving network apparatuses 104 via, for example, an air interface without routing communications via one or more elements of the network 106. Alternatively, one or more of the terminal apparatuses 102 may be configured to communicate with one or more of the serving network apparatuses 104 over the network 106. In this regard, the serving network apparatuses 104 may comprise one or more nodes of the network 106. For example, in some example embodiments, the serving network apparatuses 104 may be at least partially embodied on one or more computing devices that comprise an element of a radio access network (RAN) portion of the network 106. In this regard, the serving network apparatuses 104 may, for example, be at least partially embodied on an access point of the network 106 (for example, a macrocell, microcell, picocell, femtocell, closed subscriber group (CSG) cell, base station, base transceiver station (BTS), node B, evolved node B, access point (AP), group owner, mesh station (STA), mesh point, and/or the like), which may, for example be configured to provide access to the network 106 (e.g., via a radio uplink) to one or more of the terminal apparatuses 102. Accordingly, each of the serving network apparatuses 104 may comprise a network node or a plurality of network nodes collectively configured to perform one or more operations attributed to the serving network apparatus 104 as described with respect to various example embodiments disclosed herein. In other embodiments, the serving network apparatuses 104 may be at least partially embodied as a database, for example an event database, alternatively or in addition to the embodiments described above.

A terminal apparatus 102 may be embodied as any computing device, such as, for example, a desktop computer, laptop computer, mobile terminal, mobile computer, mobile phone, mobile communication device, tablet computing device, game device, digital camera/camcorder, audio/video player, television device, radio receiver, digital video recorder, positioning device, wrist watch, portable digital assistant (PDA), fixed transceiver device (e.g., attached to traffic lights, energy meters, light bulbs, and/or the like), a chipset, an apparatus comprising a chipset, any combination thereof, and/or the like.

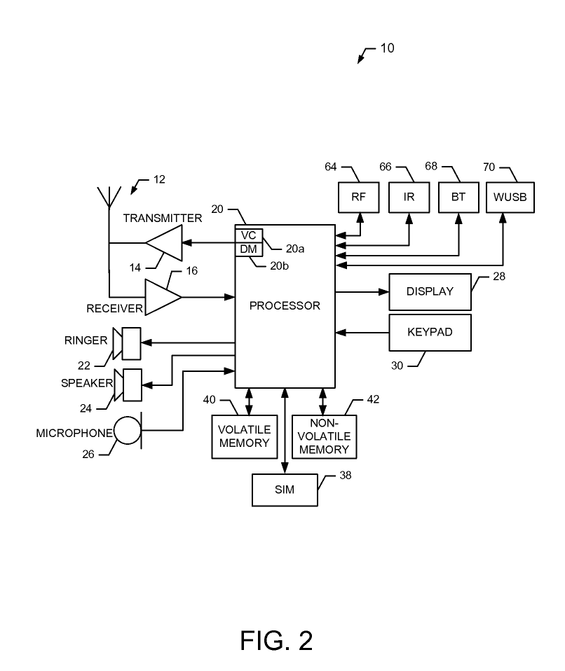

In some example embodiments, a terminal apparatus 102 may be embodied as a mobile terminal, such as that illustrated in FIG. 2. In this regard, FIG. 2 illustrates a block diagram of a mobile terminal 10 representative of one embodiment of a terminal apparatus 102. It should be understood, however, that the mobile terminal 10 illustrated and hereinafter described is merely illustrative of one type of computing device (i.e., terminal apparatus 102) that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof Accordingly, although illustrated in FIG. 2 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Bluetooth™ (BT), Ultra-wideband (UWB), Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols such as LTE Advanced and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX™) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to low power/energy or ultra-low power/energy Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The mobile terminal 10 may comprise memory, such as a removable or non-removable subscriber identity module (SIM) 38, a soft SIM 38, a fixed SIM 38, a removable or non-removable universal subscriber identity module (USIM) 38, a soft USIM 38, a fixed USIM 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may comprise a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

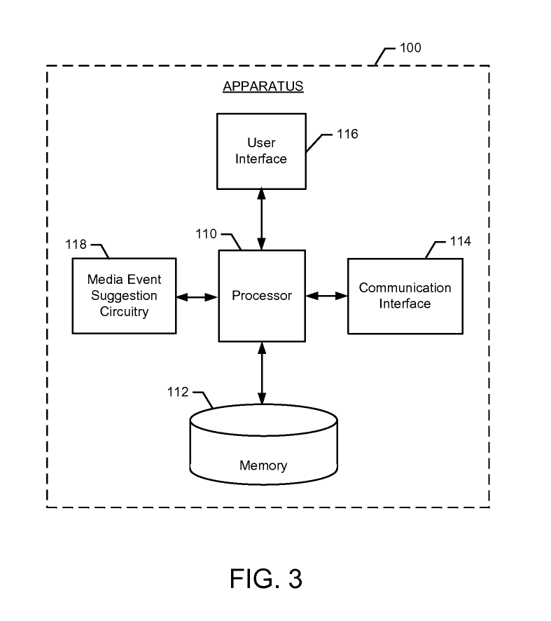

In various embodiments, for example, a terminal apparatus 102 and/or a serving network apparatus 104 may be embodied as or otherwise include an apparatus 100 as generically represented by the block diagram of FIG. 3. In the example embodiment, the apparatus 100 may comprise various means for performing the various functions herein described. These means may comprise one or more of a processor 110, memory 112, communication interface 114, user interface 116, or media event suggestion circuitry 118. The means of the apparatus 100 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., memory 112) that is executable by a suitably configured processing device (e.g., the processor 110), or some combination thereof

In some example embodiments, one or more of the means illustrated in FIG. 3 may be embodied as a chip or chip set. In other words, the apparatus 100 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 110, memory 112, communication interface 114, user interface 116, and/or media event suggestion circuitry 118 may be embodied as a chip or chip set. The apparatus 100 may therefore, in some example embodiments, be configured to implement embodiments of the present invention on a single chip or as a single “system on a chip.” As another example, in some example embodiments, the apparatus 100 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 3 as a single processor, in some embodiments the processor 110 may comprise a plurality of processors. The plurality of processors may be in operative communication with each other and may be collectively configured to perform one or more functionalities of the apparatus 100 as described herein. The plurality of processors may be embodied on a single computing device or distributed across a plurality of computing devices collectively configured to function as the apparatus 100. In embodiments wherein the apparatus 100 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the apparatus 100 to perform one or more of the functionalities of the apparatus 100 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise one or more tangible and/or non-transitory computer-readable storage media that may include volatile and/or non-volatile memory. Although illustrated in FIG. 3 as a single memory, the memory 112 may comprise a plurality of memories. The plurality of memories may be embodied on a single computing device or may be distributed across a plurality of computing devices collectively configured to function as the apparatus 100. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 100 is embodied as a mobile terminal 10, the memory 112 may comprise the volatile memory 40 and/or the non-volatile memory 42. The memory 112 may be configured to store information, data, applications, instructions, or the like for enabling the apparatus 100 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the media event suggestion circuitry 118 during the course of performing its functionalities.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to another computing device. In an example embodiment, the communication interface 114 may be at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 100 and one or more computing devices or computing resources may be in communication. As an example, the communication interface 114 may be configured to enable communication between the apparatus 100 and another device, such as another terminal apparatus 102 or serving network apparatus 104. As a further example, the communication interface 114 may be configured to enable communication with another terminal apparatus 102 or serving network apparatus 104 via the network 106. The communication interface 114 may additionally be in communication with the memory 112, user interface 116, and/or media event suggestion circuitry 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or media event suggestion circuitry 118, such as via a bus.

The media event suggestion circuitry 118 may be embodied as various means, such as circuitry, hardware, a computer program product comprising computer readable program instructions stored on a computer readable medium (for example, the memory 112) and executed by a processing device (for example, the processor 110), or some combination thereof and, in some embodiments, is embodied as or otherwise controlled by the processor 110. In embodiments wherein the media event suggestion circuitry 118 is embodied separately from the processor 110, the media event suggestion circuitry 118 may be in communication with the processor 110. The media event suggestion circuitry 118 may further be in communication with one or more of the memory 112, communication interface 114, or user interface 116, such as via a bus.

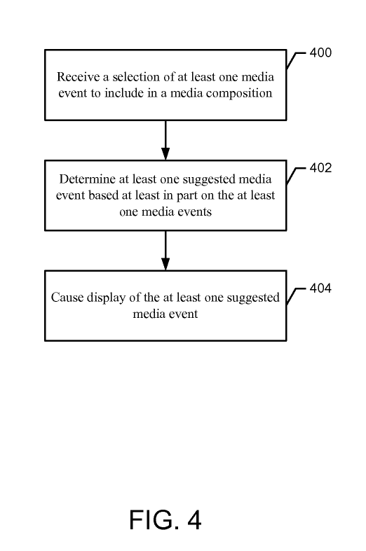

FIG. 4 is a flowchart illustrating the operations performed by a method, apparatus, and computer program product, such as apparatus 100 of FIG. 3, from the perspective of a terminal apparatus 102 in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 112 of an apparatus 100 employing an embodiment of the present invention and executed by a processor 110 in the apparatus, in some instances via media event suggestion circuitry 118.

As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

As such, the operations of FIG. 4, when executed, convert a computer or processing circuitry into a particular machine configured to perform an example embodiment of the present invention. Accordingly, the operations of FIG. 4 define an algorithm for configuring a computer or processing circuitry, e.g., processor 110, to perform an example embodiment. In some cases, a general purpose computer may be provided with an instance of the processor which performs the algorithm of FIG. 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Referring now to FIG.4, the operations performed by a method, apparatus and computer program product of an example embodiment are illustrated from the perspective of an apparatus 100 embodied as a terminal apparatus 102 that provides media event suggestions based at least in part on a co-occurrence model. In this regard, a co-occurrence model comprising the probability of various media events co-occurring may be used to provide suggestions of media events to include in a media composition based at least in part on the current contents of a media composition and/or a media event recently added to the media composition.

The apparatus 100 embodied by the terminal apparatus 102 may include means, such as the media event suggestion circuitry 118, the processor 110 or the like, for receiving a selection of at least one media event to include in a media composition. See block 400 of FIG. 4. In some instances, the media composition may comprise an audio composition, video composition, audiovisual composition, and/or the like. The media events may comprise, for example, all or a portion of a media segment, such as an audio segment, video segment, and/or the like. A media event may represent an event that occurs within all or a part of the media segment. For example, in an instance in which the media segment comprises an audio segment of a car crash, a media event within the audio segment may comprise brakes screeching, a car horn honking, glass shattering, and/or the like.

To receive the selection of at least one media event, the apparatus 100, such as the media event suggestion circuitry 118 or the processor 110, may be configured to provide for display of a media editor (e.g., an audio, video, or audiovisual editor) comprising an interface (e.g., user interface 116) for selecting the media events. In some embodiments, the interface may be a graphical interface comprising a window for displaying one or more media events. The window may be divided into various sections. For example, the window may include a section for displaying a representation of the media composition, a section for displaying a representation of the one or more media events, and/or the like. In this regard, the representations of the media composition and media events may comprise a visualization of an audio waveform, one or more frames or clips of a video, and/or the like. The media composition section may, in some instances, comprise a timeline representation of the media composition. In these embodiments, the apparatus 100 may permit the user to concatenate, mix, overlap, or otherwise combine one or more media elements at one or more times on the timeline. The media events section may comprise one or more representations of the various media events available for the user to include in the media composition. In order to select one or more media events for inclusion in the media composition, the apparatus 100 may be configured to allow a user of the interface to transfer (e.g., drag and drop) one or more of the displayed media events, or copies of the media events, from the media events section of the interface to the media composition section of the interface.

In example embodiments, the user interface may further permit the user to record or create one or more media segments to be included in the media composition. In these embodiments, one or more of the created media segments may be concatenated, mixed, overlapped, or otherwise combined with one or more of the media events to generate the media composition.

The displayed media events may correspond to one or more media events stored locally by the terminal apparatus 102 (e.g., in memory 112) or remotely by a serving network apparatus 104 (e.g., a database) accessible by the terminal apparatus 102. For example, the one or more media events may be stored by a database configured to operate as a media content provider. In an instance in which one or more of the media events are stored remotely, the apparatus 100 may be configured to provide for transmission a request to the serving network apparatus 104 for the one or more media events, or a representation thereof. The apparatus 100 may be further configured to receive the one or more media events, or a representation thereof, in response to the request. The apparatus 100 may be configured to populate the media events section of the user interface of the media editor with the one or more media events, whether the one or more media events are stored locally or remotely.

After receiving a selection of at least one media event to include in the media composition, the apparatus 100, such as the media event suggestion circuitry 118 or the processor 110, may be configured to provide for determining at least one suggested media event based at least in part on the selected at least one media event. See block 402 of FIG. 4. In this regard, the apparatus 100 may be configured to access a co-occurrence model database. The apparatus 100 may comprise the co-occurrence model, or, in some embodiments, the co-occurrence model may be external to the apparatus, for example in a serving network apparatus 104.

The co-occurrence model may identify one or more media events media events likely to occur concurrently or close in time with the selected media event or events. For example, if the selected media event corresponds to an audio clip of a bird singing, the co-occurrence model may identify and provide probabilities for an audio clip of wind through trees, grasshoppers, bees buzzing, and/or the like. The media events of this example may be linked by the co-occurrence model based on the high probability of the sounds commonly occurring together, for example in nature (e.g., in a field) during the summer time. The co-occurrence model may further provide a probability for each of the identified media events, such that the probability indicates the likelihood of the media event occurring concurrently or close in time to the selected media event. In this regard, the co-occurrence model may identify one or more suggested media events to be further added to the media composition based on the probabilities.

According to example embodiments, the apparatus 100, such as the media event suggestion circuitry 118 or the processor 110, may be configured to cause display of the at least one suggested media event. See block 404 of FIG. 4. In this regard, the apparatus 100 may be configured to designate a section of the user interface of the media editor for displaying the one or more suggested media events to the user. In some instances, the suggested media event section may display the one or more suggested media events in a list. Each element of the list may comprise one or more of a name of the media event, a representation of the media event (e.g., video still, audio wave form, etc.), a probability of co-occurrence of the media event with the selected media event, a statement of the similarity of the events (e.g., “media event A typically co-occurs with media event B”), and/or the like. In other embodiments, the apparatus 100 may be configured to display the suggested media events using different visualizations, such as in a graph or using balloons or circles. The list elements and/or other visualizations may provide a visual indication of the probability of the co-occurrence of the suggested media element and the selected media element. For example, a suggested media element with a relatively high probability of co-occurrence may be displayed in a size relatively larger than other suggested media elements with relatively low probabilities of co-occurrence.

It should be noted that while the above embodiments describe the suggested media events and their probability of co-occurrence with respect to the selected media event, the other media segments and/or media events of the media composition may further be considered in determining the suggested media events and probabilities. For example, the co-occurrence model may receive as input just the selected media event or a combination of the media event and one or more media segments and/or events of the media composition. Thus, the probabilities of co-occurrence may be based on co-occurrence with just the selected media event or with one or more of the selected media event and/or one or more of the media segments or events of the media composition. For example, the apparatus 100 may maintain a list of the one or more media segments or events, as well as the number of times they occur in certain instances, currently included in the media composition.

The apparatus 100 may determine new suggested media events each time the user adds a new media event to the media composition. In this regard, the apparatus 100 may further update the suggested media events section of the interface of the media editor to reflect the new suggested media events based on the new media event added to the media composition.

### Co-Occurrence Model Training

According to example embodiments, the co-occurrence model may be based at least in part on probabilistic latent semantic analysis (PLSA). For example, co-occurrence probabilities may be modeled as a combination of conditionally independent multinomial distributions involving a latent variable, known as aspect model, representing one or more topics. The apparatus 100 may train the co-occurrence model (e.g., the PLSA model) using a plurality of media events (e.g., media events stored in a database). In some embodiments, the media events may be overlapping. The media events may comprise annotations, for example, identifying the start and/or end times of the respective media event. In example embodiments, the apparatus 100 may consider information about co-occurrence of media events in fixed length media segments. Within a media segment, the apparatus 100 may estimate for each media event present in the database the percentage of its active state. In example embodiments, the database may be represented by a count matrix. The rows of the count matrix may represent the media events and the columns of the count matrix may represent the active time of each media event in consecutive time segments. The elements of the matrix may be, for example, any value from zero to one, whereby zero indicates that the media event is not active and one represents the media event being active for the entire duration of the considered media segment.

The apparatus 100, according to example embodiments, may factorize the count matrix, for example using an expectation maximization algorithm, into two components that represent the media events by topic conditional probability and topics by media segment conditional probability. In certain embodiments, these two components may be the components of the PLSA model. The chosen number of topics (e.g., latent variables) may be much smaller than the number of media events or the number of media segments, which may lead to, in certain instances, a robust estimation of the two components.

The apparatus 100, according to various embodiments, may obtain an initial estimate for the prior probabilities of different media events, based at least in part on the distribution of topics in the training data. In an instance in which the user selects a media event to be added to the system, the probabilities of all of the media events may be updated based on the PLSA model. That is, the apparatus may update the probabilities each time a new media event is selected, as each media event added to the system may change the local topic. In this regard, a local topic may be determined by the media events already selected, and, may subsequently determine the media events that are most probable to co-occur with them.

In example embodiments, one or more predefined categories of media event models may exist, each of which may comprise a co-occurrence model for the particular category. For example, different categories may exist for different musical genres or different audio ambiances. Example audio ambiances may include, for example, action, comedy, street, forest, restaurant, and/or the like. Each category may comprise a set of related media events, and the apparatus 100 may train a co-occurrence model for the media events.

According to various embodiments, the apparatus 100 may provide for display of a list of categories. In these instances, a user may select a particular category from the list to enable the media event model corresponding to the category. In this regard, the list of suggested media events may be selected from the particular category. As a result, the relevancy of the suggestions may be improved. In an example embodiment, the user may be required to add a media event to the media composition prior to the apparatus 100 reducing the display of suggested media events to those of the particular category.

In other embodiments, the apparatus 100 may be configured to apply a media category classifier, such as a media context classifier, to the media composition. In these instances, the apparatus 100 may automatically analyze the context of the media composition to classify the media composition into a category. The apparatus 100, according to example embodiments, may select the media event model associated with a particular category based at least in part on the classification. For example, in an instance in which the apparatus 100 classified the media composition as being associated with the category “street,” the apparatus may select the media event co-occurrence model associated with the category “street.”

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
receiving a selection of at least one media event to include in a media composition;
determining at least one suggested media event based at least in part on the at least one media events; and
causing display of the at least one suggested media event.

2. The method according to claim 1, further comprising:
receiving a selection of one or more media events of the at least one suggested media events; and
adding the one or more media events of the at least one suggested media events to the media composition.

3. The method according to claim 2, further comprising:
updating the at least one suggested media events based at least in part on the selection of the one or more media events of the at least one suggested media events; and
providing for display of the updated at least one suggested media events.

4. The method according to claim 1, wherein determining at least one suggested media event further comprises:
determining the at least one suggested media event based at least in part on a probability of the at least one suggested media event co-occurring with the at least one selected media events.

5. The method according to claim 1, wherein the media composition comprises at least one other media event in addition to the selected at least one media event, and wherein determining at least one suggested media event further comprises determining at least one suggested media event based at least in part on the at least one selected media event and the at least one other media event.

6. The method according to claim 5, wherein determining at least one suggested media event further comprises:
determining the at least one suggested media event based at least in part on a probability of the at least one suggested media event co-occurring with the at least one selected media event and the at least one other media event included in the media composition.

7. The method according to claim 1, wherein causing display of the at least one suggested media event further comprises:
causing display of a first suggested media event having a first co-occurrence probability; and
causing display of a second suggested media event having a second co-occurrence probability; wherein the display of the first suggested media event differs from the display of the second suggested media event in an instance in which the first co-occurrence probability differs from the second co-occurrence probability.

8. An apparatus comprising:
at least one processor; and
at least one memory comprising computer program code, the at least one memory and the computer program code configured to, with the at least one processor, cause the apparatus at least to:
receive a selection of at least one media event to include in a media composition;
determine at least one suggested media event based at least in part on the at least one media events; and
cause display of the at least one suggested media event.

9. The apparatus according to claim 8, wherein the at least one memory and the computer program code are further configured to, with the at least one processor, cause the apparatus to:
receive a selection of one or more media events of the at least one suggested media events; and
add the one or more media events of the at least one suggested media events to the media composition.

10. The apparatus according to claim 9, wherein the at least one memory and the computer program code are further configured to, with the at least one processor, cause the apparatus to:
update the at least one suggested media events based at least in part on the selection of the one or more media events of the at least one suggested media events; and
provide for display of the updated at least one suggested media events.

11. The apparatus according to claim 8, wherein in order to determine the at least one suggested media event, the at least one memory and the computer program code are further configured to, with the at least one processor, cause the apparatus to:
determine the at least one suggested media event based at least in part on a probability of the at least one suggested media event co-occurring with the at least one selected media events.

12. The apparatus according to claim 8, wherein the media composition comprises at least one other media event in addition to the selected at least one media event, and wherein in order to determine the at least one suggested media event, the at least one memory and the computer program code are further configured to, with the at least one processor, cause the apparatus to determine the at least one suggested media event based at least in part on the at least one selected media event and the at least one other media event.

13. The apparatus according to claim 12, wherein in order to determine the at least one suggested media event, the at least one memory and the computer program code are further configured to, with the at least one processor, cause the apparatus to:
determine the at least one suggested media event based at least in part on a probability of the at least one suggested media event co-occurring with the at least one selected media event and the at least one other media event included in the media composition.

14. The apparatus according to claim 8, wherein in order to cause display of the at least one suggested media event, the at least one memory and the computer program code are further configured to, with the at least one processor, cause the apparatus to:
cause display of a first suggested media event having a first co-occurrence probability; and
cause display of a second suggested media event having a second co-occurrence probability; wherein the display of the first suggested media event differs from the display of the second suggested media event in an instance in which the first co-occurrence probability differs from the second co-occurrence probability.

15. A computer program product comprising a non-transitory computer-readable medium bearing computer program code embodied therein for use with a computer, the computer program code comprising:
code for receiving a selection of at least one media event to include in a media composition;
code for determining at least one suggested media event based at least in part on the at least one media events; and
code for causing display of the at least one suggested media event.

16. The computer program product according to claim 15, the computer program code further comprising:
code for receiving a selection of one or more media events of the at least one suggested media events; and
code for adding the one or more media events of the at least one suggested media events to the media composition.

17. The computer program product according to claim 16, the computer program code further comprising:
code for updating the at least one suggested media events based at least in part on the selection of the one or more media events of the at least one suggested media events; and
code for providing for display of the updated at least one suggested media events.

18. The computer program product according to claim 15, wherein the computer program code for determining at least one suggested media event further comprises:
code for determining the at least one suggested media event based at least in part on a probability of the at least one suggested media event co-occurring with the at least one selected media event.

19. The computer program product according to claim 15, wherein the media composition comprises at least one other media event in addition to the selected at least one media event, and wherein the computer program code for determining at least one suggested media event further comprises code for determining at least one suggested media event based at least in part on the at least one selected media event and the at least one other media event.

20. The computer program product according to claim 19, wherein the computer program code for determining at least one suggested media event further comprises:
code for determining the at least one suggested media event based at least in part on a probability of the at least one suggested media event co-occurring with the at least one selected media event and the at least one other media event included in the media composition.

21. The computer program product according to claim 15, wherein the computer program code for causing display of the at least one suggested media event further comprises:
code for causing display of a first suggested media event having a first co-occurrence probability; and
code for causing display of a second suggested media event having a second co-occurrence probability; wherein the display of the first suggested media event differs from the display of the second suggested media event in an instance in which the first co-occurrence probability differs from the second co-occurrence probability.

22-28. (canceled)
